(19) United States
(12) Patent Application Publication
(10) Pub. No.: US 2004/0208284 A1
(43) Pub. Date: Oct. 21, 2004

(54) X-ray optical system for combinatorial screening of a sample library

(75) Inventors: Lutz Brugemann, Durmersheim (DE); Arnt Kern, Karlsruhe (DE)

Correspondence Address: Kohler Schmid + Partner, Ruppmannstr. 27, D-70565 Stuttgart, DE

(73) Assignee: Bruker AXS GmbH, Karlsruhe (DE)

(21) Appl. No.: 10/810,819

(22) Filed: Mar. 29, 2004

(30) Foreign Application Priority Data
Apr. 17, 2003 (DE) 103 17 678.0

(51) Int. Cl. G01N 23/20; H05G 1/00

(52) U.S. Cl. 378/70

(57) ABSTRACT

An X-ray optical system for combinatorial screening comprising a plurality of samples which are disposed on a flat plate (8;23) as a sample library (3;22), with an X-ray source (1) from which X-ray radiation (2) is guided to a sample under investigation, and an X-ray detector (7) for receiving radiation (6) diffracted or scattered on the sample, wherein a sample carrier is provided for displacing the flat plate (8;23) in its xy-plane and perpendicular thereto along a z-direction, is characterized in that the sample carrier is designed such that it can rotate the flat plate (8;23) about a first axis (9) parallel to the z-direction and also about a second axis (10) which extends through the xy-plane. This permits rapid sequential measurement of the samples of a sample library, wherein a large variety of X-ray analyses can be applied to the samples.

This application claims Paris Convention priority of DE 103 17 678.0 filed Apr. 17, 2003 the complete disclosure of which is hereby incorporated by reference.

### BACKGROUND OF THE INVENTION

The invention concerns an X-ray optical system for combinatorial screening of a plurality of samples which are disposed on a flat plate as a sample library, with an X-ray source from which X-ray radiation is guided to the sample under investigation, and an X-ray detector for detecting radiation diffracted or scattered on the sample, wherein a sample carrier is provided for displacing the flat plate in its xy-plane and along a z-direction perpendicular thereto.

An X-ray optical system of this type is disclosed e.g. in the company document “DIFFRACTION SOLUTIONS for Combinatorical Screening-D8 DISCOVER with GADDS”, Bruker AXS Inc., 5465 East Cheryl Parkway, Madison, Wis. 53711, USA, 2000, in particular pages 4-5.

X-ray analysis methods are used in various ways for material investigation and chemical analysis to obtain information about the structure and/or composition of preferably crystalline samples. Towards this end, an X-ray beam is directed from an X-ray source onto the sample and scattered, diffracted, or characteristic emitted X-rays from the sample are registered in an X-ray detector. The spatial position and/or the intensity of the X-rays gives information about the interaction between the irradiated X-rays and the sample and therefore about the properties of the sample.

To accelerate X-ray analyses for a large number of samples, a device described in the above-mentioned company document of Bruker AXS Inc. uses sample libraries. A sample library typically consists of a flat plate having a plurality of regularly disposed depressions or holders, each for receiving one individual sample. To be able to change quickly from one sample to the next during X-ray analysis, the sample library can be translated in the plane of the flat plate (xy-plane), i.e. by a sample carrier spacing, as well as perpendicular to the plane of the flat plate (z-direction). The device shown in the company document of Bruker AXS Inc. permits displacement of the X-ray source and X-ray detector along a circular path about the sample carrier to carry out theta-2theta measurements.

This device is disadvantageous in that it positions the samples relative to the X-ray source and X-ray detector. However, the samples cannot be freely oriented, which severely limits the type of X-ray analyses which can be carried out with the individual samples of a sample library.

Departing therefrom, it is the underlying purpose of the present invention to provide an X-ray optical system for rapid sequential measurement of the samples of a sample library, wherein a large variety of X-ray analyses can be applied to the samples.

### SUMMARY OF THE INVENTION

This object is achieved in a surprisingly simple but effective fashion with an X-ray optical system of the above-mentioned type in that the sample carrier is designed such that it can rotate the flat plate about a first axis parallel to the z-direction and also about a second axis which extends through the xy-plane.

Rotation of the flat plates about two, non-parallel axes permits free orientation of the individual samples in space relative to the spatial position of X-ray source and X-ray detector, thereby permitting a much larger number of X-ray analysis methods to be carried out than were possible in prior art.

Particularly for the case of monocrystalline samples, the crystallographic planes of the monocrystal can be oriented to permit access to certain diffractive patterns for detection, despite the random orientation of the monocrystal in the sample library. In accordance with the invention, the spatial orientation of a sample can also be changed during a measurement, i.e. to permit measurement of pole figures.

One embodiment of the inventive X-ray optical system is particularly preferred, with which the sample carrier is designed such that the first and second axes intersect. This reduces the required pivot region of the sample carrier during orientation and the space required for its associated orientation mechanics.

In one further particularly preferred development of this embodiment, the flat plate can be displaced such that each sample of the sample library can be shifted to the point of intersection between the first and second axes. If a sample is located at the point of intersection between the first and second axes, orientation of the sample by turning about the first or second axes does not result in translatory motion of the sample. Orientation and positioning of the sample can be adjusted directly and independently of each other. The point of intersection between the first and second axes can be illuminated by the X-ray source and be scanned by the detector, i.e. be used as a measuring position of the sample.

In one further advantageous embodiment of the inventive system, the source and/or the detector or the flat plate are disposed to be rotatable about a third axis. This provides additional orientation possibilities for the samples thereby facilitating additional X-ray analysis methods and rendering the X-ray analysis methods easier or more flexible.

In an advantageous further development of this embodiment, the directions of the first, second and third axes are substantially orthogonal, which facilitates orientation of the flat plate or of the samples.

In one additional preferred embodiment, the source and the detector can be moved and disposed on a same as well as on opposite sides of the flat plate. The X-ray optical system is then fundamentally suited to perform both transmission and reflection experiments.

In another advantageous embodiment, the flat plate has openings at the sample positions for transmission measurements. The openings reduce the amount of interfering radiation incident on the detector during transmission experiments.

In an alternative, advantageous embodiment for reflection measurements, the flat plate is impermeable to X-ray radiation. This eliminates interfering radiation through diffraction or scattering from the side of the flat plate facing away from the samples.

The present invention also comprises a method for combinatorial screening of a plurality of samples which are disposed on a flat plate as a sample library, in particular for operation with the above-mentioned inventive X-ray optical system, wherein the samples are successively moved into a measuring position through linear displacement along the x-, y- and z-directions and are illuminated with X-ray radiation from an X-ray source from which they direct the scattered X-ray radiation to an X-ray detector. The invention is characterized in that, for optimizing the X-ray radiation scattered to the detector, the samples are rotated about a first axis perpendicular to the plate plane and/or about a second axis extending in the plate plane, and a measurement is carried out in each optimized measuring position. Application of this method also permits recording of diffraction patterns of samples having random initial orientation, from any spatial direction, i.e. along a certain zone axis of a monocrystalline sample. In particular, a sample can also be oriented such that a particularly highly scattering crystallite of several crystallites in the sample is oriented for X-ray measurement. This is advantageous, in particular, when the sample comprises only few crystallites and therefore does not behave like a powder sample.

In one preferred variant of the inventive method, the samples are moved about their respective measuring position in the plate plane to optimize the X-ray radiation scattered to the detector. When the intensity maximum has been reached, the sample position can be fixed or adjusted for X-ray measurement, thereby improving the signal-to-background ratio.

One method variant is also preferred with which the samples are moved linearly in a z-direction, perpendicular to the plate plane.

One further advantageous method variant is characterized in that at least part of the motions of the samples along the x-, y- or z-direction and/or about the first or the second axis are oscillated (=“wobbled”) during the respective measurement. When the source X-rays illuminate only part of the sample, this motion of the sample leads to averaging over more parts of the sample. The detector registers an intensity which is averaged relative to the orientation distribution of the crystallites in the sample. Random, irregular distribution of the sample material (i.e. on the edges of the container) is not critical for the measurement.

Further advantages of the invention can be extracted from the description and the drawing. The features mentioned above and below can be used in accordance with the invention individually or collectively in arbitrary combination. The embodiments shown and described are not to be understood as exhaustive enumeration but have exemplary character for describing the invention.

The invention is shown in the drawing and is explained in more detail with reference to embodiments.

### BRIEF DESCRIPTION OF THE DRAWING

FIG. 1 shows an embodiment of the inventive X-ray optical system with a path of rays in reflection;

FIG. 2 shows an embodiment of the inventive X-ray optical system with a path of rays in transmission.

### DESCRIPTION OF THE PREFERRED EMBODIMENT

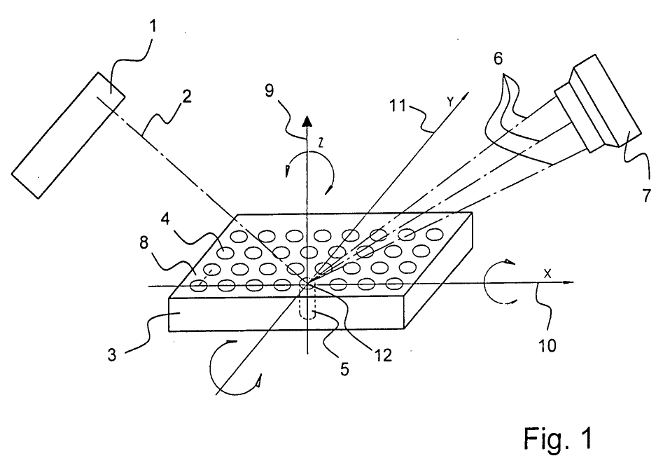

FIG. 1 shows an embodiment of an inventive X-ray optical system. An X-ray source 1 emits an X-ray 2 which is rendered parallel or focussed through suitable X-ray optics (not shown). A sample library 3 comprises several depressions 4, each of which accommodates one sample of the material under investigation. A selected depression 5 of the plurality of depressions 4, is positioned in the X-ray beam 2. The material located in the selected depression 5 interacts with the X-ray beam 2 thereby generating several diffracted X-rays 6. The diffracted X-rays 6 are detected by an X-ray detector 7 which is directed towards the selected depression 5. The X-ray detector 7 is designed as a 2-dimensional area detector.

The upper side of the sample library 3, i.e. the side facing the X-ray source 1 and the X-ray detector 7, is designed as flat plate 8. The openings of the depressions 4 are all located in the plate plane of the flat plate 8. To select another of the depressions 4 for a measurement, instead of depression 5, the flat plate 8 and therefore the sample library 3 can be displaced in the x- and/or y-direction, i.e. in the plane of the flat plate 8. The flat plate 8 can also be displaced in a z-direction perpendicular to the plate plane, i.e. to take into consideration the actual length of samples projecting from the depressions 4. The flat plate can be displaced in the x-, y- or z-direction to obtain an intensity maximum for the diffracted X-ray radiation 6. In the embodiment shown, the translatory motion of the flat plate 8 is effected through electric motors (not shown) via a sample carrier (not shown), to which the sample library 3 is mounted.

The sample library 3 and the flat plate 8 can also be rotated about a first axis 9, i.e. the z-axis, and about a second axis 10, i.e. the x-axis. The X-ray source 1 or the sample library 3 and the X-ray detector 7 can be rotated about the y-axis 11, wherein the separation from the selected depression 5 remains constant. The rotations are performed by electric step motors (not shown). The three axes 9, 10, 11 are orthogonal to each other and cross at a point of intersection 12. The selected depression 5 and therefore the sample to be currently measured is also located at this point of intersection 12.

If the sample to be currently measured is to be oriented in a particular fashion relative to the impinging X-ray beam 2 or relative to the position of the detector 7, this can be effected through tilting the sample library 3 about one or more of the three axes 9, 10, 11. Rotation about the first axis 9 and/or about the second axis 10 is sufficient for free orientation of the sample library 3. Rotation about the third axis 11 can facilitate the orientation process. Rotation of the sample library 3 does not change the position of the selected depression 5 in space, i.e. the selected depression 5 remains in the impinging X-ray beam 2 and in the detection region of the detector 7. The orientation of the sample in the selected depression 5 does therefore not depend on its position in space and can be directly adjusted. Conversely, for a given orientation of the sample library 3, i.e. a specific orientation of the normal to the plate plane of the flat plane 8, the position of the sample library 3 (and therefore the selected depression 5) can be directly selected irrespective of the sample library orientation.

To also maintain this independence for a selection of other depressions 4, the motion mechanics of the sample carrier to which the sample library 3 is mounted, is designed such that the position of the point of intersection 12, i.e. the point of intersection of the axes of rotation 9, 10, and 11, are absolutely stationary in space. The translatory motions of the sample library in x-, y- and z-direction are performed relative to its point of intersection 12. The sample carrier may e.g. be directly hinged to a rotary mechanics of the axes 9, 10, 11, while the flat plate 8 is displaced in the three directions x, y, z relative to the sample carrier. An X-Y dependence of the motion components is then approximately effected via the first axis 9, and a Z-dependence via the second axis 10, preferably in that order.

The free orientation of the sample before and during measurement provides the user of the inventive X-ray optical system with numerous different X-ray analysis methods, wherein fast sample change between samples of a sample library 3 is facilitated. The free orientation of the samples can be utilized, like the translatory motion, to increase the intensity through orientation of the sample. High intensity is obtained, in particular, when crystallites in a sample having a size larger than average meet the Bragg condition.

If an X-ray measurement produces an intensity maximum for the diffracted X-ray beam 6, a considerably amount of sample material is present in the impinging X-ray beam 2. To dispose such a considerable amount of sample material in the X-ray beam 2 is relatively difficult for a sample comprising only few microcrystallites, i.e. due to a small titration volume prior to the decrystallization process. The impinging X-ray beam 2 also generates an X-ray fluorescent signal in the sample material, i.e. characteristic X-ray radiation of the sample material, which can be used for element analysis. Preferably, an energy-dispersive X-ray detector can also be provided in the inventive X-ray optical system in addition to the spatially resolving X-ray detector 7 to also permit energy-dispersive element analysis along with the diffractometric analysis of each sample. An energy-dispersive X-ray detector should be disposed as close as possible to the irradiated sample and face it.

In the embodiment of FIG. 1, the X-ray source 1 and the detector 7 are disposed above the plate plane of the flat plate 8. For this reason, this embodiment is suited to carry out X-ray experiments in reflection.

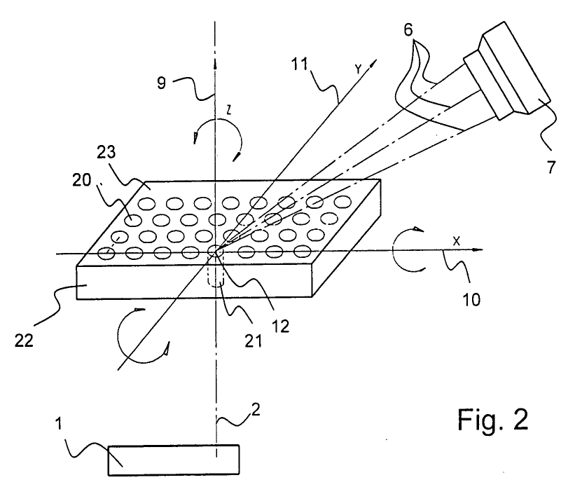

FIG. 2 shows a further embodiment of an inventive X-ray optical system. The X-ray source 1 emits an X-ray beam 2 which is incident on a sample library 22 which comprises a plurality of holes (openings) 20 in which the respective samples under investigation are disposed. The X-ray beam 2 is incident on a sample in one of the openings 20, i.e. in the selected opening 21. Interaction between the X-ray beam 2 and the sample in the selected opening 21 produces several diffracted X-rays 7 which are registered by a detector 7. The detector 7 is designed as two-dimensional area detector.

The sample library 22 is formed on its upper side (and also lower side) as flat plate 23. In the embodiment of FIG. 2, the X-ray source 1 is disposed below the plate plane of the flat plate 23 while the detector 7 is disposed above the plate plane of the flat plate 23. For this reason, this embodiment is suited to carry out transmission experiments. The X-ray source 1 and/or the detector 7 are preferably pivotable from below to above the plate plane of the flat plane 23 and back.

Like the sample library 3 of the embodiment of FIG. 1, the sample library 22 can be translatorily displaced in three spatial directions x, y, z and can be rotated about a first axis 9, a second axis 10 and a third axis 11. The measuring position of the samples is located at the point of intersection 12 of the three axes 9, 10, 11.

We claim:

1. An X-ray optical system for examination of a sample selected from a plurality of samples of a sample library, the system comprising:
an X-ray source from which X-ray radiation is guided onto the selected sample;
a flat plate on which the plurality of samples is disposed;
an X-ray detector for receiving radiation from the selected sample;
means for displacing said flat plate in an xy-plane, substantially parallel to an upper surface of said plate;
means for displacing said flat plate in a z-direction, substantially perpendicular to said xy-plane;
means for rotating said flat plate about a first axis parallel to said z-direction; and
means for rotating said flat plate about a second axis extending through said xy-plane.

2. The system of claim 1, wherein said first axis and said second axis intersect.

3. The system of claim 2, wherein said flat plate can be displaced such that each sample of the sample library can be displaced into a point of intersection between said first axis and said second axis.

4. The system of claim 1, wherein at least one of said source, said detector, and said flat plate are disposed to be rotatable about a third axis.

5. The system of claim 4, wherein said first axis, said second axis and said third axis are substantially orthogonal.

6. The system of claim 1, wherein said source and said detector can be positioned on a same side of said flat plate.

7. The system of claim 1, wherein said source and said detector can be positioned on opposite sides of said flat plate.

8. The system of claim 1, wherein said flat plate has openings at sample positions for transmission measurements.

9. The system of claim 1, wherein said flat plate is impermeable to said X-ray radiation for reflection measurements.

10. A method for examining a plurality of samples disposed on a flat plate as a sample library, the method comprising the steps of:
a) selecting one of said plurality of samples and positioning said selected sample into a measuring position for illumination with X-ray radiation from an X-ray source and for passage of X-ray radiation from said selected sample to an X-ray detector;
b) displacing said selected sample in at least one of an x-direction lying in a plane of said flat plate, a y-direction perpendicular to said x-direction and lying in said plane of said flat plate, and a z-direction perpendicular to both said x-direction and said y-direction;
c) rotating said selected sample about at least one of a first axis perpendicular to said x- and said y-directions and a second axis lying in said plane of said flat plate, wherein steps b) and c) are performed to optimize radiation from said selected sample on said detector; and
d) carrying out a measurement of said selected sample followings steps a) through c).

11. The method of claim 10, wherein said selected samples is moved about a respective measuring position in said plate plane to optimize X-ray radiation scattered to said detector.

12. The method of claim 10, wherein said selected sample is moved linearly in said z-direction.

13. The method of claim 10, wherein at least one motion of said selected sample along said x-direction, along said y-direction, along said z-direction, about said first axis, and about said second axis is wobbled during a respective measurement.
